(19) United States
(12) Patent Application Publication
(10) Pub. No.: US 2007/0173584 A1
(43) Pub. Date: Jul. 26, 2007

(54) COMPOSITE POLYMERS

(75) Inventors: Helena Twardowska-Baxter, Dublin, OH (US); Michael J. Sumner, Dublin, OH (US); Dennis H. Fisher, Westerville, OH (US); Timothy A. Tufts, Powell, OH (US)

Correspondence Address: CONNOLLY BOVE LODGE & HUTZ LLP, P.O. BOX 2207, WILMINGTON, DE, 19899-2207, US

(73) Assignee: ASHLAND LICENSING AND INTELLECTUAL PROPERTY LLC, Dublin, OH (US)

(21) Appl. No.: 11/307,080

(22) Filed: Jan. 23, 2006

(51) Int. Cl. C08K 9/04

(52) U.S. Cl. 524/445

(57) ABSTRACT

The present disclosure relates generally to reinforced composite resin formulations used for molding body panels for transportation vehicles. Particularly, but not by way of limitation, the disclosure relates to low-density thermosetting composite molding compounds used to mold body panels and having a density of less than 1.6 grams/cubic centimeter and excellent surface smoothness without the use of hollow glass microspheres.

### FIELD OF THE INVENTION

The present invention relates generally to the preparation of cosmetic body panels having Class A Surface Quality from polymeric, low-density composites.

### BACKGROUND

The information provided below is not admitted to be prior art to the present invention, but is provided solely to assist the understanding of the reader.

With the continued increase in energy costs, the transportation industry has a strong desire to reduce the weight of their vehicles to improve fuel economy. This need to produce lighter vehicle parts has opened the door for the use of low density metals and polymers. Polymeric materials are now being used extensively to replace steel parts on vehicles due to their light weight, ability to be molded into complex shapes, i.e. part consolidation and design flexibility, corrosion resistance, strength, and resistance to damage. In particular, thermoset composites are widely used to prepare structural (inner) and cosmetic (outer) body panels. The automotive industry has very stringent requirements for the surface appearance of cosmetic body panels. The desired smooth surface is generally referred to as a “Class A” surface. Surface quality (SQ), as measured by the Laser Optical Reflected Image Analyzer (LORIA), is determined by three measurements—Ashland Index (AI), Distinctness of Image (DOI), and Orange Peel (OP). SMC with Class A SQ is typically defined as having an AI<80, a DOI≧70 (scale 0-100), and an OP≧7.0 (scale 0-10).

Nearly all thermoset polymers show shrinkage, on a volume basis, as they are cured. In a fiber reinforced polymer thermoset composite (FRP), this results in a very uneven surface because the reinforcing fibers cause peaks and valleys when the resin shrinks around them. A variety of methods have been used to help thermoset composites meet the stringent surface smoothness requirements for a class A surface and enabling the formulation of composites that meet or exceed the smoothness of the metal parts, which were typically used in these applications.

A common method used to reduce cure shrinkage and improve surface smoothness is to incorporate large amounts of inorganic fillers, such as calcium carbonate (CaCO₃), into the composite's formulation. Typically, the filler content of the formulation will be about equal to that of the resin on a volume basis. Thus, filler addition reduces the cure shrinkage of the overall composition simply because there is significantly less polymeric material to undergo shrinkage.

With the increasing pressure in the industry to improve gas mileage, manufacturers are working harder and harder to reduce the weight of their vehicles. While FRP's have an advantage over most competitive materials because of lower specific gravity, the high density of the inorganic fillers and fiber reinforcement, typically glass, causes the part to be heavier than necessary. Most inorganic fillers and fiber reinforcement have a high density compared to polymeric thermoset resins. For example, calcium carbonate and glass fiber, the most commonly used filler and reinforcement, both have a density of about 2.7 g/cc. Even though a typical cured thermoset, such as cured unsaturated polyester, has a density of about 1.2 g/cc, the filler and glass fiber increase the density of a FRP body panel to about 1.9 g/cc. Reducing the density of these parts by 15 to 25%, while maintaining the other desirable properties of the FRP, could result in significant weight savings for the vehicle.

The industry has expressed a need for low-density composite molding compounds yielding parts having Class A Surface Quality. Some suppliers have attempted to reduce the part density by replacing a portion of the heavy inorganic fillers with hollow glass microspheres. While this technique significantly reduces density without a substantial drop in SQ, molded cosmetic panels made in this way show substantial reduction in the mechanical properties and matrix toughness shown by the present high-density molding compounds that are unacceptable to the industry. To make this situation worse, the use glass microspheres increases the number of parts flawed by “paint popping” at a time when a number of newly introduced, high-density systems are yielding parts showing a significant reduction in such flaws.

While maintaining Class A SQ and other desired properties as part density is reduced appears more and more difficult, the following disclosure will show that cosmetic molded parts having a 15 to 25% drop in density can be accomplished without microspheres and with little or no loss in SQ, mechanicals, matrix toughness or resistance to “paint popping”.

### SUMMARY OF THE INVENTION

The present invention addresses the unmet needs of the prior art by providing strong, tough, low-density molded composite parts having Class A SQ and density not greater than about 1.6 grams/cubic centimeter without to use of glass microspheres. It provides these properties by use of a molded fiber reinforced composite formulated with dramatically reduced levels of standard filler types such as nanoclay, diatomaceous earth, mica, wollastonite (CaSiO₃), kaolin clay, graphite, ground carbon fiber, cellulose-based fillers, and similar materials.

An aspect of the present invention provides low-density moldings having an average linear shrinkage, compared to the mold, of about −0.02 to +0.15 percent and a “Class A” surface. The surface quality (SQ), as measured by the Laser Optical Reflected Image Analyzer (LORIA), is determined by three measurements—Ashland Index (AI), Distinctness of Image (DOI), and Orange Peel (OP). For the purpose of this invention, moldings are defined as having a Class A SQ when possessing an AI<85, a DOI≧70 (scale 0-100), and an OP≧7.0 (scale 0-10).

An aspect of the present invention provides reinforced composite panels having a density below 1.6 grams/cubic centimeter. According to a further aspect, the panels do not contain either filled or hollow glass microspheres.

According to yet a further aspect, the panels are formed from a thermoset molding compound, which, when molded into a flat panel without reinforcement, has an average linear cure shrinkage, when compared to the cold mold, of −0.1 to +0.2 percent.

According to yet a further aspect, the panels are formed from a thermoset molding compound, which, when molded into a flat panel with reinforcement, has an average linear cure shrinkage, when compared to the cold mold, of −0.02 to +0.15 percent.

According to yet a further aspect, the panels are formed from a thermoset molding compound, which, , when molded, with reinforcement, into a flat panel approximately 0.1 inch (2.54 millimeters) thick on a highly polished mold, has a surface smoothness, as defined by the Ashland Index (AI), Distinctness of Image (DOI), and Orange Peel (OP) values measured by a Laser Optical Reflected Image Analyzer (LORIA), of AI<85, DOI≧70 (scale 0-100), and OP≧7.0 (scale 0-10).

Still other aspects and advantages of the present invention will become readily apparent by those skilled in the art from the following detailed description, wherein it is shown and described preferred embodiments of the invention, simply by way of illustration of the best mode contemplated of carrying out the invention. For considerations of convenience, the invention is described in terms of reinforced composite body panels for transportation vehicles. However, the invention is not limited to either body panels or to transportation vehicles. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF THE DRAWINGS

The invention is best understood from the following detailed description when read in connection with the accompanying drawing. Included in the drawing are the following figure:

FIG. 1 is a table describing the impact of various filler(s) on Surface Quality of parts molded at 300° F. from the inventive low density formulations.

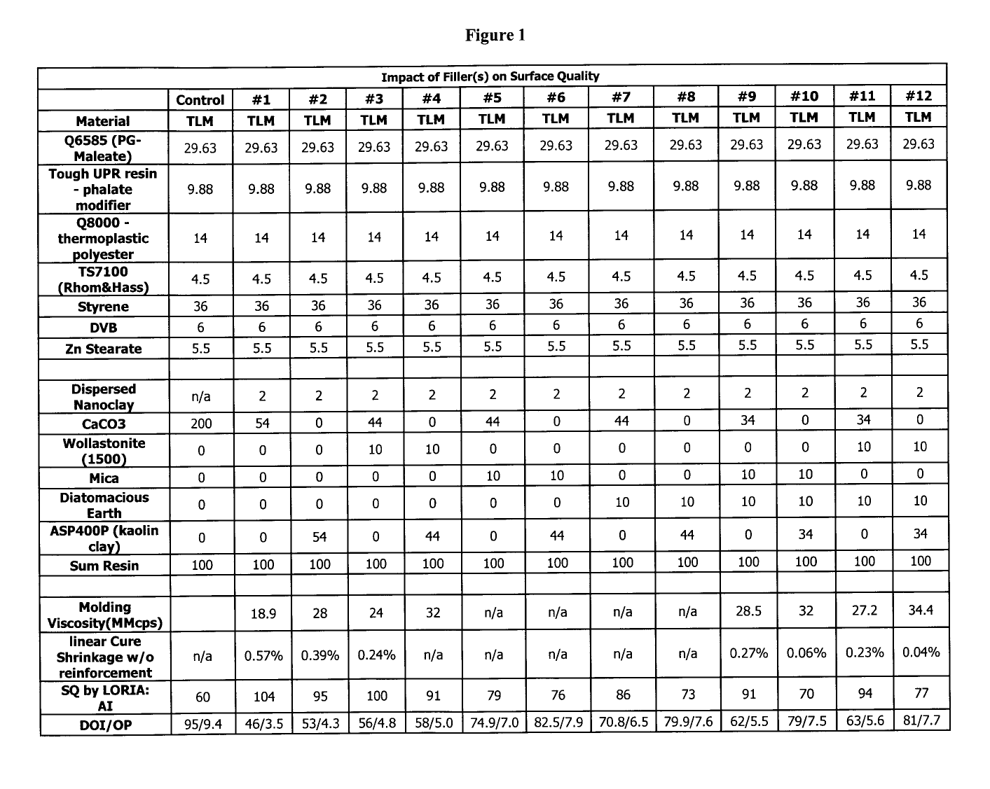

It is to be noted, however, that the appended drawing illustrates only typical embodiments of this invention and are therefore not to be considered limiting of its scope, for the invention may admit to other equally effective embodiments.

### DETAILED DESCRIPTION OF THE PREFERRED EMBODIMENT

Standard composite parts from thermosetting polymers are used extensively in the transportation industry. Typical such composite formulations contain high concentrations higher density inorganic fillers, i.e. CaCO₃ filler at levels>180 parts per 100 parts of organic resins, to help reduce the cure shrinkage of the formulation. These high filler levels, coupled with the fiber reinforcement, produced molded composite panels having a much higher density, i.e.≧1.9 grams/centimeter³ (g/cc), than their polymeric components′ density of about 1.2 grams/centimeter³ (g/cc).

At present there is a strong demand for tough, lower density composite cosmetic parts (specific gravity<1.6 g/cc) with Class A surface quality in the transportation industry. However, due to industry mechanical and thermal requirements, most composite molding compounds are formulated from various polymeric thermosetting resins that typically show significant shrinkage during cure. This “cure shrinkage” can result in molded composites having a very rough surface due to the resin shrinking around the fiber reinforcement. Current techniques to reduce shrinkage typically include the use of large amounts of higher density fillers, such as calcium carbonate and clay to produce cosmetic composite moldings having both good strength and smooth surface appearance. Unfortunately, these formulations often contain>70 weight percent higher density filler and fiber reinforcement and have a density≧1.9 g/cm³.

The steady increase in fuel prices and need to reduce the generation of “green house gases”, i.e. carbon dioxide (CO₂), make the improved energy efficiency seen from lighter vehicles utilizing lower density composite parts highly desirable. However, the weight savings realized with such lower density parts is of no use if the high strength, toughness (i.e. crack and ‘paint pop’ resistance), or good surface appearance typically found in higher density Class A composites is lost. For example, it is well known that replacing a portion of the high density fillers with hollow glass microspheres can significantly reduce density while maintaining SQ. However, glass microspheres are unacceptable in Class A cosmetic applications as they reduce the composite's strength, toughness, and “paint pop” resistance and make the repair of painting flaws nearly impossible.

It is also well known that the mechanical properties of thermoset composite moldings are highly dependent on the level and type of its fiber reinforcement. Since maintaining the required strength and toughness leaves little flexibility to adjust the level and type of fiber reinforcement, formulating acceptable lower density cosmetic composites appears dependent on dramatically reducing the filler level without significantly changing its desired properties. Evaluation of Lower density formulations has shown that simply reducing the level of CaCO₃ used in standard systems will not yield an acceptable low density Class A molded part. Rather, complete reformulation of the resin and replacement of the CaCO₃ with a blend of high surface area fillers is required to achieve the above objectives.

A preferred methodology for the determination of surface quality is by use of a Laser Optical Reflected Image Analyzer, i.e. LORIA as disclosed by Hupp (US4,853,777), the entire content of which is specifically incorporated by reference for all purposes. Surface quality (SQ), as measured by LORIA, is determined by three measurements—Ashland Index (AI), Distinctness of Image (DOI), and Orange Peel (OP). SMC with Class A SQ is typically defined as having an AI<85, a DOI≧70 (scale 0-100), and an OP≧7.0 (scale 0-10).

An example of a conventional “toughened” thermoset composite molding formulation could have the following approximate composition: 39 g of a highly reactive, toughened unsaturated polyester (UPE) resin; 14 g of thermoplastic low profile additive (LPA), 3-4 g of thermoplastic rubber impact modifier; 40-45 g of reactive vinyl monomer, i.e. styrene monomer; 190-200 g of CaCO₃ filler; 9-10 g of magnesium oxide thickener; 4-5 g mold release; 1.5 g tertiary butyl perbenzoate free-radical initiator; and 0.05 g of an “activator”, i.e. cobalt, to speed up the generation of free-radicals by said initiator. Such conventional molding formulations typically have a density of>1.9 g/cc.

The present invention is designed to provide a molding formulation to mold cosmetic parts having a density of from 1.45 to 1.6 g/cc while maintaining the mechanical properties, toughness, paint pop resistance, and Class A SQ of higher density parts. A lower density, molding composition might be comprised of 38-40 g of a highly reactive, toughened unsaturated polyester (UPE) resin; 14 g of thermoplastic low profile additive (LPA), 3-4 g of thermoplastic rubber impact modifier; 40-45 g of reactive vinyl monomer, i.e. styrene monomer; 35-65 g of mixed filler; 9-10 g of magnesium oxide thickener; 4-5 g mold release; 1.5-1.7 g of free-radical initiator; and 0.05 g of an “activator”, i.e. cobalt, to speed up the generation of free-radicals by said initiator. The mixed filler might include filler types such as nanoclay (organically treated clays that delaminate into nanoplatelets when subjected to shear during mixing), diatomaceous earth, mica, wollastonite (CaSiO₃), kaolin clay, graphite, ground carbon fiber, cellulose-based fillers, and similar materials.

A typical filler package for lower density molding compound might include 1-6 g of nanoclay, 0-20 g of diatomaceous earth, 0 to 25 g mica, 0 to 25 g wollastonite, and/or 0 to 60 g of kaolin clay, CaCO3, graphite, ground carbon fiber, or cellulosic organic. Combinations of these fillers will typically total 35 to 65 g per 100 g of organic resins and reactive monomers. Filler levels at the high end of the range tend to yield better mechanical properties and SQ, however, they increase density and can increase the formulation viscosity and make preparation of the molding compound more difficult. The filled resin paste viscosity is typically kept between 15,000 and 35,000 cps to ensure proper ‘wet-out’ of the fiber reinforcement prior to molding.

Sheet molding compound paste (SMC-paste) formulations and reinforced, sheet molding compounds (SMC) suitable for purposes of the present invention have been described in co-pending applications 11/124,356; 11/124,294; and 11/124,354, the contents of which are incorporated by reference in their respective entireties and for all purposes. SMC-paste formulations comprise at least one thermosetting resin, as described in co-pending application 11/124,356; at least one ethylenically unsaturated monomer, as described in co-pending application 11/124,356; at least one low profiling additive, as described in co-pending application 11/124,356; a nanoclay filler composition, as described in co-pending application 11/124,356. An aspect of the present invention provides that the SMC-paste does not contain either filled or hollow glass microspheres. A further aspect of the invention provides that the SMC-paste has a density less than about 1.25 g/cm³.

In preferred aspects, the thermosetting resin is a toughened, high-elongation unsaturated polyester resin as described in co-pending application 11/124,356. Preferred, but non-limiting toughened, high-elongation unsaturated polyester resins comprise a polyethylene glycol maleate UPE modified with at least one substituent selected from the group consisting of aromatic dibasic acids, aliphatic dibasic acids, glycols having from 2 to 8 carbons, and mixtures thereof.

According to alternative preferred aspects, the thermosetting resin comprises from about 10 mole percent to about 40 mole percent of a phthalate-modified, maleic-glycol polyester resin and from about 60 mole percent to about 90 mole percent of a maleic-glycol polyester resin as described in co-pending application 11/124,354.

According to preferred aspects, the SMC-paste formulations further comprise an alternative reactive monomer consisting of an aromatic, multiethylenically-unsaturated monomer as described in co-pending application 11/124,294. A preferred, but non-limiting, alternative reactive monomer is divinylbenzene.

SMC-paste formulations suitable for purposes of the present invention may further comprise a reinforcing mineral filler as described in co-pending application 11/124,356. Preferred, but non limiting mineral fillers include mica, wollastonite, and mixtures thereof.

SMC-paste formulations suitable for purposes of the present invention may further comprise an organic filler as described in co-pending application 11/124,356. Preferred, but non-limiting organic fillers include graphite, ground carbon fiber, celluloses, polymers, and mixtures thereof.

Ethylenically unsaturated monomers suitable for purposes of the present invention have been described in co-pending application 11/124,356. Suitable ethylenically-unsaturated monomers include, but are not limited to: acrylates, methacrylates, methyl methacrylate, 2-ethylhexyl acrylate, styrene, divinyl benzene and substituted styrenes, multi-functional acrylates, ethylene glycol dimethacrylate, trimethylol propanetriacrylate, and mixtures thereof. A preferred ethylenically unsaturated monomer is styrene.

Suitable low profiling additives are thermoplastic resins as described in co-pending application 11/124,356. Suitable low profiling thermoplastic resins include, but are not limited to saturated polyester, polyurethane, polyvinyl acetate, polymethylmethacrylate, polystyrene, epoxy-extended polyester, and mixtures thereof.

The SMC-paste formulations may further comprise a LPA-enhancer as described in co-pending application 11/124,356.

The SMC-paste formulations may further comprise a rubber impact modifier as described in co-pending application 11/124,356.

The SMC-paste formulations may further comprise at least one auxiliary component selected from the group consisting of mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof as described in co-pending application 11/124,356.

Low-density sheet molding compounds (SMC) suitable for purposes of the present invention have been described in co-pending applications 11/124,356; 11/124,294; and 11/124,354. Briefly, low-density sheet molding compounds suitable for purposes of the present invention comprise a fibrous roving material and an SMC-paste as described above. Suitable SMC have densities less than about 1.6 g/cm³. The SMC of the present invention do not contain glass microspheres.

Aspects of the present invention provide articles of manufacture comprising the low-density SMC and/or SMC-pastes as described above.

Aspects of the invention provide methods of fabricating an article of manufacture. The inventive methods include at least heating under pressure the low-density SMC and/or SMC-pastes described above.

In an aspect, a method of fabricating a low-density SMC is provided. The method comprises forming a nanoclay composite in situ within an uncured resin—monomer mixture and curing said mixture, wherein said SMC molding has a density less than about 1.6 g/cm³.

Aspects of the invention also provide a process for making molded composite vehicle and construction parts having a density less than 1.6 grams per cm³. The process comprises admixing an unsaturated polyester thermosetting resin, an olefinically unsaturated monomer capable of copolymerizing with the unsaturated polyester resin, a thermoplastic low profile additive, free radical initiator, alkaline earth oxide or hydroxide thickening agent, and a nanoclay composite filler composition; forming a paste; dispensing said paste on a carrier film above and below a bed of roving, forming a molding sheet; enveloping the sheet in the carrier film; consolidating the sheet; maturing the sheet until a matured molding viscosity of 3 million to 70 million centipoise is attained and the sheet is non-tacky, releasing the sheet from the carrier film; compression molding the sheet into a part in a heated mold under pressure whereby a uniform flow of resin, filler, and glass occurs outward to the edges of the part; and removing the molded part.

In preferred aspects of the process, parts are formed by molding under a pressure of from 200 psi to 1400 psi and more preferably from 400 psi to 800 psi. In preferred aspects of the process, parts are formed by molding at a temperature of from 250° F. to 315° F., more preferably from 270° F. to 290° F., and most preferably from 275° F. to 285° F.

According to the method, SMC-paste and/or SMC formulations are provided onto the surface of a highly-polished mold and formed under heat and pressure into a flat panel approximately 0.1 inch (2.54 millimeters) thick. The SMC-paste and/or SMC formulations do not contain glass microspheres. The resulting panel has a surface smoothness, as defined by the Ashland Index (AI), Distinctness of Image (DOI), and Orange Peel (OP) values measured by a Laser Optical Reflected Image Analyzer (LORIA), of AI<85, DOI≧70 (scale 0-100), and OP≧7.0 (scale 0-10). Preferably, the molded part has a surface smoothness quality less than a 75 Ashland LORIA analyzer index. The surface smoothness is a function of the mold surface into which the SMC-paste is pressed. In the above definition, a highly-polished mold refers to a mold that has been polished to a mirror finish. As understood in the industry, a mirror finish refers to a “#8Finish,” the most reflective finish commonly produced on sheet, also known as mirror or polished. It is produced by polishing with successively finer abrasives, then buffing with a very fine buffing compounds or rouges. The surface is essentially free of grit lines from preliminary grinding operations, though, at certain angles, some may still be visible.

The invention is illustrated with one example. Resin paste formulations without reinforcement were cured and evaluated for “linear shrinkage” with the best being mixed with fiber reinforcement and molded into flat, 12 inch by 12 inch reinforced panels about 0.1 inches thick. The panels were tested for density, surface appearance, and mechanical strength. The surface appearance was analyzed using a LORIA surface analyzer to measure the Ashland Index for ‘long term waviness’ and the Distinctness of Image (DOI) and Orange Peel (OP) for ‘short term’ surface distortion.

The data in Table I shows the formulations containing nanoclay plus lowered filler level required to yield lower density, 1.5-1.6 g/cc, molded panels. Note the excellent overall SQ of the control (˜1.9 g/cc). The data for formulations TLM-1 through TLM-8 clearly show that obtaining a lower density SMC with acceptable SQ is not simply a matter of reducing the CaCO₃ level. In fact, they show the necessity of employing a mixture of fillers having differing shapes and surface area to prepare an acceptable molded panel. The data also show that a correct mix of fillers is key. Note that TLM-5 and TLM-7, which contain CaCO₃, show significantly more shrinkage and reduced SQ compared to TLM-6 and TLM-8 where clay is the third filler component.

It should be noted that cure shrinkage can be significantly reduced by using higher levels of highly structured fillers such as nanoclay, wollastonite, mica, and diatomaceous earth. However, increased levels of such fillers cause a large increase in the viscosity of the resin paste and gives poor fiber ‘wet-out’ when preparing reinforced molding compound. Poor fiber ‘wet-out’ causes a multitude of problems when the part is molded, including poor SQ, reduced physical properties, delamination, and ‘blistering’.

### INCORPORATION BY REFERENCE

All publications, patents, and pre-grant patent application publications cited in this specification are herein incorporated by reference, and for any and all purposes, as if each individual publication or patent application were specifically and individually indicated to be incorporated by reference. In particular co-pending applications 11/124,356; 11/124,294; and 11/124,354 are specifically incorporated by reference. In the case of inconsistencies the present disclosure will prevail.

What is claimed as new and desired to be protected by Letters Patent of the United States is:

1. A reinforced composite body panel for transportation vehicles comprising:
a thermoset molding compound, which, when molded, with reinforcement, into a flat panel approximately 0.1 inch (2.54 millimeters) thick on a highly polished mold, has a surface smoothness, as defined by the Ashland Index (AI), Distinctness of Image (DOI), and Orange Peel (OP) values measured by a Laser Optical Reflected Image Analyzer (LORIA), of AI<85, DOI≧70 (scale 0-100), and OP≧7.0 (scale 0-10);
wherein said panel has a density below 1.6 grams/cubic centimeter, without hollow glass microspheres; and
wherein said panel does not comprise glass microspheres.

2. The reinforced composite body panel for transportation vehicles, according to claim 1, comprising a thermoset molding compound, which, when molded into a flat panel without reinforcement, has average linear cure shrinkage, when compared to the cold mold, of −0.1 to +0.2 percent.

3. The reinforced composite body panel for transportation vehicles, according to claim 1, comprising a thermoset molding compound, which, when molded into a flat panel with reinforcement, has a linear cure shrinkage, when compared to the cold mold, of −0.02 to +0.15 percent.

4. A sheet molding compound paste (SMC-paste) formulation comprising:
a thermosetting resin,
an ethylenically unsaturated monomer;
a low profiling additive;
a nanoclay filler composition;
wherein said SMC-paste does not contain glass microspheres; and
wherein said SMC-paste has a density less than about 1.25 g/cm³.

5. The SMC-paste formulation, according to claim 1, further comprising a reinforcing mineral filler.

6. The SMC-paste formulation, according to claim 2, wherein said mineral filler is selected from the group consisting of mica, wollastonite, and mixtures thereof.

7. The SMC-paste formulation, according to claim 1, further comprising an organic filler selected from the group consisting of graphite, ground carbon fiber, celluloses, polymers, and mixtures thereof.

8. The SMC-paste formulation, according to claim 1, wherein said thermosetting resin is a toughened, high-elongation unsaturated polyester resin.

9. The SMC-paste formulation, according to claim 6, wherein said toughened, high-elongation UPE comprises a polyethylene glycol maleate UPE modified with at least one substituent selected from the group consisting of aromatic dibasic acids, aliphatic dibasic acids, glycols having from 2 to 8 carbons, and mixtures thereof.

10. The SMC-paste formulation, according to claim 1, wherein said ethylenically unsaturated monomer is selected from the group consisting of acrylate, methacrylates, methyl methacrylate, 2-ethylhexyl acrylate, styrene, divinyl benzene and substituted styrenes, multi-functional acrylates, ethylene glycol dimethacrylate, trimethylol propanetriacrylate, and mixtures thereof.

11. The SMC-paste formulation, according to claim 7, wherein a preferred ethylenically unsaturated monomer is styrene.

12. The SMC-paste formulation, according to claim 1, wherein said low profiling additive is a thermoplastic resin.

13. The SMC-paste formulation, according to claim 9, wherein said low profiling thermoplastic resin is selected from the group consisting of saturated polyester, polyurethane, polyvinyl acetate, polyacrylates, polymethacrylates , polystyrene, epoxy-extended polyester, and mixtures thereof.

14. The SMC-paste formulation, according to claim 9, further comprising a LPA-enhancer.

15. The SMC-paste formulation, according to claim 1, further comprising a rubber impact modifier.

16. The SMC-paste formulation, according to claim 1, further comprising an alternative reactive monomer comprising an aromatic, multiethylenically-unsaturated monomer.

17. The SMC-paste formulation, according to claim 1, wherein said resin comprises:
from about 10 mole percent to about 40 mole percent phthalate modified, maleic-glycol polyester resin; and
from about 60 mole percent to about 90 mole percent maleic—glycol polyester resin.

18. The SMC-paste formulation, according to claim 1, further comprising at least one additive selected from the group consisting of organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

19. A low-density sheet molding compound (SMC) comprising:
a fibrous roving material; and
the SMC-paste of claim 1
wherein said SMC has a density less than about 1.6 g/cm³.

20. An article of manufacture comprising the low-density SMC of claim 14.

21. The article of manufacture, according to claim 15, wherein said article has a Class A Surface Quality.

22. A method of fabricating an article of manufacture comprising heating under pressure the low-density SMC of claim 14.

23. The method of fabricating a low-density SMC, according to claim 27, further comprising providing auxiliary components selected from the group consisting of mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

24. A method of fabricating a low-density SMC comprising forming a nanoclay composite in situ within an uncured resin—monomer mixture and curing said mixture, wherein said SMC molding has a density less than about 1.6 g/cm³.

25. A process for making molded articles of manufacture having a density less than 1.6 grams per cm³, comprising:
admixing unsaturated polyester thermosetting resin, an olefinically unsaturated monomer capable of copolymerizing with the unsaturated polyester resin, a thermoplastic low profile additive, free radical initiator, alkaline earth oxide or hydroxide thickening agent, and a nanoclay composite filler composition;
forming a paste;
dispensing said paste on a carrier film above and below a bed of roving,
forming a molding sheet;
enveloping said sheet in the carrier film;
consolidating said sheet;
maturing said sheet until a matured molding viscosity of 3 million to 70 million centipoise is attained and said sheet is non-tacky,
releasing said sheet from said carrier film;
compression molding said sheet into a part in a heated mold under pressure whereby a uniform flow of resin, filler and glass occurs outward to the edges of said part; and
removing said molded part.

26. The process for making molded articles of manufacture, according to claim 25, wherein said molding pressure for the part is from 200 psi to 1400 psi; preferably from 400 psi to 800 psi.

27. The process for making molded articles of manufacture, according to claim 25, wherein said molding temperature for the part is from 250° F. to 315° F.; preferably from 270° F. to 290° F.; and most preferably from 275°0 F. to 285°0 F.

28. The process for making molded articles of manufacture, according to claim 25, wherein said molded part has a surface smoothness quality less than a 100 Ashland LORIA analyzer index.
